(19) United States
(12) Patent Application Publication
(10) Pub. No.: US 2003/0065840 A1
(43) Pub. Date: Apr. 3, 2003

(54) Computer-assisted testing method for a wiring system

(76) Inventors: Toni Kress, Lauf (DE); Norbert Pantenburg, Nuernberg (DE); Andre Turnaus, Nurnberg (DE); Dieter Walter, Hessdorf (DE)

Correspondence Address: HARNESS, DICKEY & PIERCE, P.L.C., P.O.BOX 8910, RESTON, VA, 20195, US

(21) Appl. No.: 10/239,235

(22) PCT Filed: Mar. 20, 2001
(86) PCT No.: PCT/DE01/01072

(30) Foreign Application Priority Data
Mar. 20, 2000 (DE) 100-13-521.8

(51) Int. Cl. G06F 13/00

(52) U.S. Cl. 710/100

(57) ABSTRACT

The topology of a wiring system in the form of a bus or network, which is to provide a number of electrical consumers (1-5) with a low voltage from a supply module (6) is input into a computer (30). At least one individual length and one individual cross-section is allocated to each of the sections (12-27) of the wiring system, while nominal capacities are allocated to the consumers (1-5). The low voltage, nominal capacities and lengths are used in conjunction with predetermined dimensioning criteria to test whether the cross-section is adequate for each section (12-27).

This application is the national phase under 35 U.S.C. §371 of PCT International Application No. PCT/DE01/01072 which has an International filing date of Mar. 20, 2001, which designated the United States of America and which claims priority on German Patent Application number DE 100 13 521.8 filed Mar. 20, 2000, the entire contents of which are hereby incorporated herein by reference.

### FIELD OF THE INVENTION

The present invention generally relates to a computer-aided test method for a wiring system. Preferably, it relates to one via which it is intended to be possible to supply a number of electrical loads with low voltage from a supply module.

### BACKGROUND OF THE INVENTION

In an industrial plant, in particular machines and machine systems, a large number of electrical low-voltage loads must be supplied with electrical power. The loads are often, but not exclusively, single-phase or three-phase AC motors. A supply with, for example, a DC voltage of 500 V is also known.

In the past, the power was distributed to the loads in switchgear cabinets, in which the supply module for loads was also arranged. Starting from the switchgear cabinet, separate cables were laid to the individual loads. The wiring system thus had a star-like topology. On the basis of this topology, namely a separate cable for each load, it was relatively simple to design the cables. This could even be done by electricians on the basis of comparatively simple tables.

Recently, the electrical loads have been connected to the supply module to an ever greater extent via bus-like or network-like wiring systems. A bus section of the wiring system originates from the supply module, and a network—which possibly has even further branches—is routed via this bus section to the individual loads. The bus section carries the total current for the connected loads. Further sections branch off to the individual loads, referred to in the following text as individual or end sections, which carry the current for only this single load.

The design and testing of such a wiring system is considerably more complex and requires considerably more effort than a star-like topology. Electricians do not have the necessary capabilities to do this. Although, in principle, electrical engineers have the necessary specialist knowledge, there are, however, no standardized dimensioning rules which are easy to handle and can be used without further problems. Even electrical engineers therefore require a considerable amount of time to carry out the design work, and to test the design, correctly.

Admittedly, it is feasible simply to add up the individual lengths of the sections and the ratings of the loads, and to design the wiring system in a standard manner as if a single load comprising the sum of the ratings had to be supplied with electrical power via a cable constituting the sum of the individual lengths of the sections. In this case, although the design will be simple, the wiring system as such would very probably be considerably overdesigned.

### SUMMARY OF THE INVENTION

An object of an embodiment of the present invention is to provide a (computer-controlled) test method. Preferably, by use of such a test method, the design of a bus-like or network-like wiring system can be checked automatically.

An object may be achieved by:

a topology of the wiring system being entered in a computer,

the bus section and the individual sections each having at least one associated dedicated length and at least one associated dedicated cross section, and the loads having associated ratings, and

the low voltage, the ratings and the lengths in conjunction with predetermined design criteria for each section being used to test whether the cross section is adequately designed.

In a simplest case, the design criteria may include only a test of the sections for overloading when the loads are being operated correctly. However, exceptional conditions, such as a predetermined overload, a short-circuit in the sections or in the loads, and/or a voltage drop are preferably also checked.

In the situation where at least two of these tests are carried out, the tests are in this case preferably carried out in the sequence mentioned above.

If, in accordance with the topology, at least two of the loads may be connected to the bus section via a common intermediate section, and at least one further load may be connected to the bus section, but not via the common intermediate section, the intermediate section may, of course, also have an associated dedicated length and an associated dedicated cross section, and the design of the intermediate section may also be checked.

If sections which connect loads to the bus section together with the intermediate section are tested first of all to determine whether they are adequately designed, and sections which connect loads to the bus section without the intermediate section are only then tested to determine whether they are adequately designed, this results in a particularly efficient procedure.

It is possible to restrict the test method purely to a test of the wiring system. However, the sections are preferably automatically optimized to ensure a minimum adequate design. It is even better for the optimization of the sections to be initiated or suppressed by presetting an appropriate control command. If laying conditions and/or operating temperatures which are associated with the sections are also entered, and the laying conditions and/or the operating temperatures are taken into account in the testing of the sections, in order to determine whether they are adequately designed. This allows an even more far-reaching check and optimization of the wiring system.

If, for at least some of the loads, a switching and protection module, which is arranged upstream of the respective load, is specified for the computer, this makes the test method particularly powerful.

If at least some of the design criteria are determined on the basis of protection parameters of the switching and protection modules, it is particularly easy for a user to carry out the test method.

If the loads, and possibly also the switching and protection modules, can be selected from a predetermined catalogue and load parameters as well as switching and protection module parameters, in particular the rating of the load and the protection parameters of the switching and protection module, are determined automatically by the selection from the catalogue, it is possible to preset the relevant characteristics of the loads and of the switching and protection modules in a particularly simple manner. Furthermore, this procedure ensures that the specified loads and switching and protection modules are actually available.

In the simplest case, a fault message is merely generated, as such, if the design is inadequate. However, the fault message is preferably also used to identify what design criterion is not satisfied, and/or the point at which an incorrect design has occurred. This means that the fault can be corrected more easily by a user.

The low voltage may optionally be a DC voltage or a signal-phase or three-phase AC voltage. In the case of a three-phase AC voltage, it is, of course, also possible to connect single-phase loads to the three-phase AC voltage.

If at least two of the loads are single-phase loads, the single-phase loads may be distributed between the phases of the wiring system in order to carry out the test method. This is because this minimizes the total load on the three-phase network. The distribution between the phases is output to the user of the test method.

If phase shifts of the currents flowing in the loads are taken into account in the testing of the sections for adequate design, the wiring system can be tested in even greater detail.

If the tested, and possibly optimized, wiring system is stored as a file, in particular as an ASCII file, the file can be read by any editor.

If a test method according to that above is carried out for at least two wiring systems, and at least the supply module is common to the wiring systems, the test method can be used in a particularly versatile manner. This is because, in practice, there is generally at least one dedicated main wiring system and two auxiliary wiring systems, one of which can be switched (by an EMERGENCY OFF), while the other cannot be switched.

Within the two auxiliary wiring systems, it is possible for the wiring systems to have at least one of the loads in common, as well. To draw a comparison between the main wiring system and the auxiliary wiring systems, one switching and protection module is frequently arranged upstream of at least one of the loads in the main wiring system, and the switching and protection module is frequently a load in an auxiliary wiring system. The main wiring system is generally operated with a single-phase AC voltage of, for example, 230 volts or a three-phase AC voltage of, for example, 400 volts. The auxiliary wiring systems are generally operated either with a DC voltage of, for example 24 volts, or with a single-phase AC voltage of, for example, 230 volts.

### BRIEF DESCRIPTION OF THE DRAWINGS

Further advantages and details may be found in the following description of an exemplary embodiment, in conjunction with the drawings in which, illustrated in outline form:

FIGS. 1 and 2 show examples of a circuit arrangement,

FIG. 3 shows a computer layout,

FIG. 4 shows a basic flowchart,

FIG. 5 shows a detail from FIG. 4, and

FIGS. 6-10 show details from FIG. 5.

### DETAILED DESCRIPTION OF THE PREFERRED EMBODIMENTS

Based on exemplary FIG. 1, five (by way of example) main loads 1 to 5 are intended to be supplied with electrical power from one supply module 6. A switching and protection module 7 to 11 is arranged upstream of each of the main loads 1 to 5. The loads 1 to 5 are generally, but not necessarily, motors. As a rule, the switching and protection modules 7 to 11 include a contactor, with a circuit breaker connected upstream of it.

A main wiring system is provided in order to supply electrical power to the main loads 1 to 5. The main loads 1 to 5 are supplied with a main low voltage via this main wiring system. The main low voltage is a voltage of less than 1 kV, for example a three-phase AC voltage with a rated voltage of, for example, 400 volts. In this case, the wiring system typically has five conductors (three phases, a neutral conductor, ground).

As shown in FIG. 1, the main low-voltage system has a main bus section 12, main inter-mediate sections 13 to 17, as well as main end sections 18 to 27. As can be seen, the switching and protection modules 7 to 11 are in this case arranged upstream of the main loads 1 to 5.

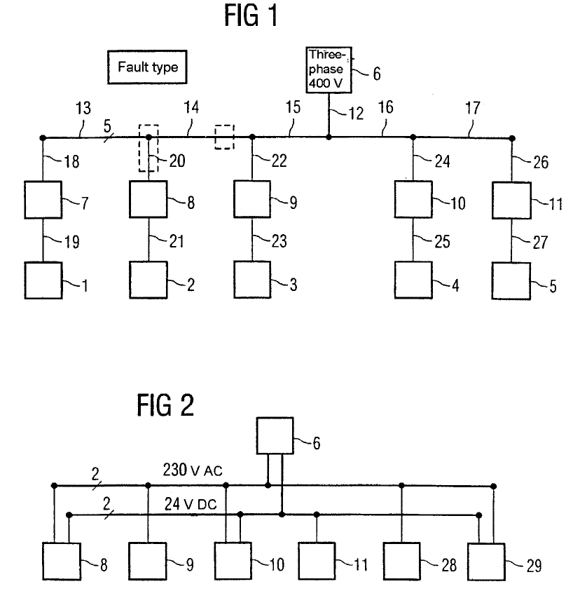

The switching and protection modules 7 to 11 are auxiliary loads, which are supplied with electrical power via auxiliary wiring systems. As can be seen in FIG. 2, the auxiliary wiring systems have the same structure as the main wiring system. The only additional feature which should be noted is that the switching and protection module 7 is not supplied with electrical power via these two auxiliary wiring systems, but in some other way. Furthermore, other components 28, 29—as replacements so to speak—which are not included in the main wiring system are connected to one or both of the auxiliary wiring systems. The other components 28, 29 may, for example, be actuators or sensors. The auxiliary loads 8 to 11, 28, 29 may also be connected to one or to both of the auxiliary wiring systems.

As a rule, the auxiliary wiring systems carry a lower voltage than the main wiring system. Typical voltage values are a single-phase AC voltage of, for example, 230 volts, or a DC voltage of, for example, 24 volts. In both cases, the auxiliary wiring systems may be designed with two conductors.

The wiring systems thus have the supply module 6 in common. Furthermore, the auxiliary wiring systems shown in FIG. 2 have common loads 8, 10, 29. The loads 8 to 11 on the auxiliary wiring systems are also switching and protection modules 8 to 11 in the main wiring system, as is illustrated in FIG. 1.

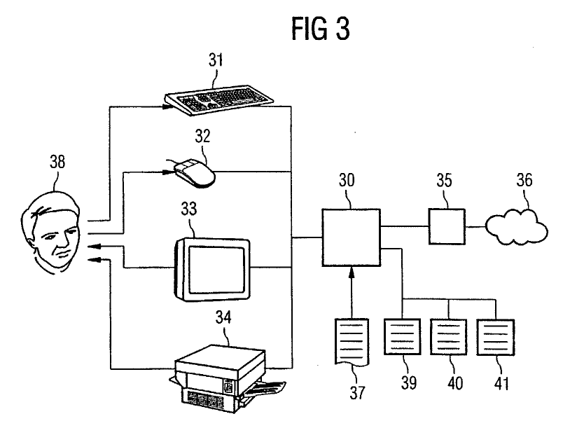

The test method according to the invention runs under program control on a computer, for example a PC. This has the normal components as shown in FIG. 3. These comprise a computer core 30, input devices 31, 32 (typically a keyboard 31 and a mouse 32), output devices 33, 34 (typically a monitor 33 and a printer 34) and, possibly, an interface 35 to a computer network 36, for example to the Internet. While processing a program 37, by which the test method according to an embodiment of the invention is implemented, the computer communicates with a user 38 and, in the process, also accesses, among other items, files 39 to 41, which are preferably ASCII files.

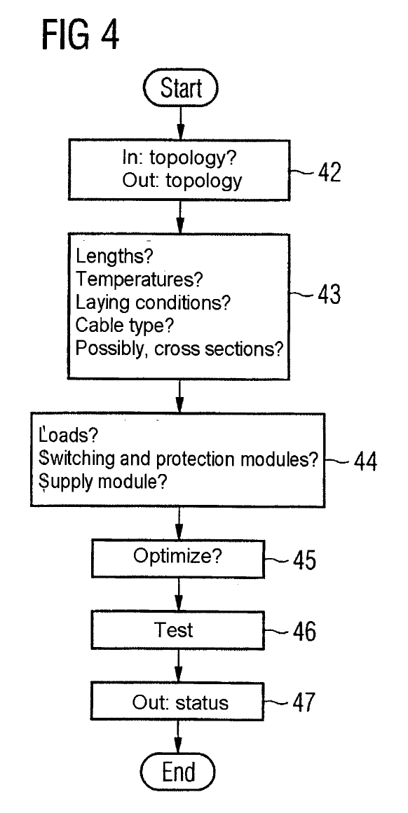

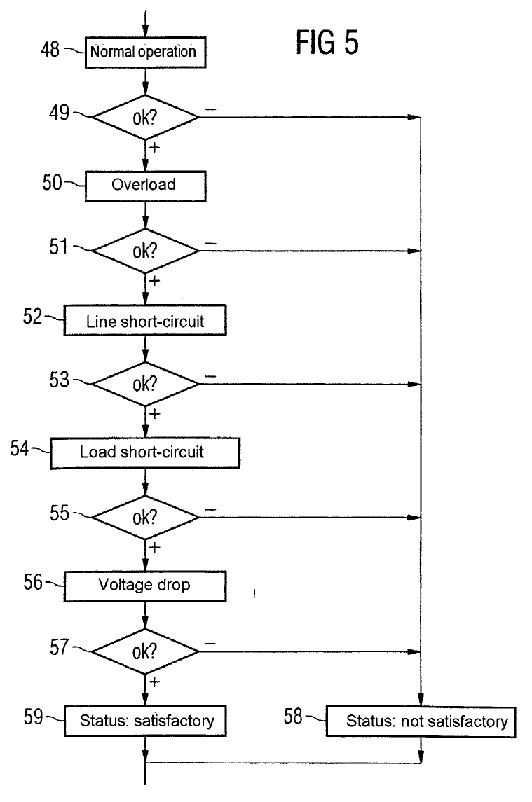

The test method according to an embodiment of the invention will be described in the following text in conjunction with FIGS. 4 to 10, on the basis of the main wiring system.

As shown in FIG. 4, the user 38 first of all, in a step 42, interactively enters the topology of the main wiring system into the computer. The computer then produces an image of the entered main wiring system on the monitor 33. Furthermore, in a step 43, the respective lengths, operating temperatures and laying conditions as well as the cable type of the cable laid or to be laid there is asked for each of the sections 12 to 27. The cable type includes, for example, the material of the casing insulation and of the conductor insulation, the conductor material and the rated voltage for which the cable is designed. The laying conditions include, for example, whether the cables are laid individually or in groups, in one layer or in bundles, with or without a gap, and whether they will be laid on the ceiling, on the wall, on the floor or in cable ducts or the like. If required, the (minimum) cross sections of the individual sections may also be specified in a step 43. In this case, the cross sections are thus allocated by the user 38.

The lengths and the operating temperatures are individual variables which can, of course, be entered numerically. In some cases, the lengths may be very large or very small. Even a length of zero is possible. In this case, the corresponding section comprises only its connecting elements, and adjacent components are connected directly to one another. The file 39 is preferably accessed with regard to the laying conditions and the cable types, by which it is possible to select a number of cable types and laying conditions. The file 39 thus first of all provides a catalogue of cable types and laying conditions.

The main loads 1 to 5, the supply module 6 as well as the switching and protection modules 7 to 11 are then specified in a step 44. The file 39 is also preferably accessed for this purpose. This also contains, inter alia, a catalogue of loads which can be selected, of supply modules which can be selected and of switching and protection modules which can be selected. Where configurable elements are selected in this case, they are configured interactively during the specification process.

The catalogue stored in the file 39 contains all the major parameters for the elements which can be selected. Both the relevant load parameters, for example the rating of a selected load, and the relevant switching and protection module parameters together with the relevant parameters for the supply module 6 are thus provided automatically by the selection. They can be determined automatically by the computer on the basis of the selection from the catalogue. The same applies to the cables and the laying conditions.

The switching and protection module parameters include, inter alia, their rated current, their overload factor and their short-circuit factor as well as their overload time. The short-circuit factor is the factor which the selected switching and protection module also uses to identify a short circuit and to immediately (that is to say within a few seconds) interrupt the circuit. Normally, it is between 10 and 20, for example 12. The overload factor is the factor by which the current must exceed the rated current for the selected switching and protection module to interrupt the circuit at the latest after the overload time. The overload factor is typically in the range between 1 and 2, for example 1.45. The overload time is normally between 30 minutes and 4 hours, for example 1 hour or 2 hours.

The sections 12 to 27 must, of course, not only be able to carry the desired rated current during normal operation, but should also be capable of being operated reliably in exceptional circumstances such an overload, short-circuit etc. For example, a cable must be able to withstand the overload current for the overload time. The design criteria for the individual sections 12 to 27 are thus also governed by the protection parameters, mentioned above, for the selected switching and protection modules.

Finally, an interactive check is carried out in a step 45 to determine whether the wiring system is intended to be optimized during the test.

The actual test of the wiring system is then carried out in a step 46. The test is in this case carried out on the basis of predetermined design criteria, which will be described in more detail in the following text. The test according to an embodiment of the invention is in this case carried out for all sections, that is to say both for the bus section 12 and for the intermediate sections 13 to 17 as well as the end sections 18 to 27. A status message is then output in a step 47. If the main wiring system 12 to 27 is adequately designed, all that is output is that the design is correct. Otherwise a fault message is produced in step 47.

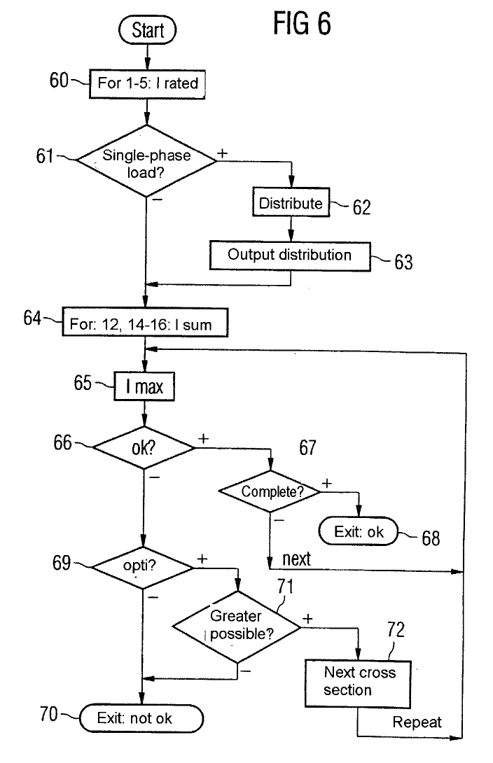

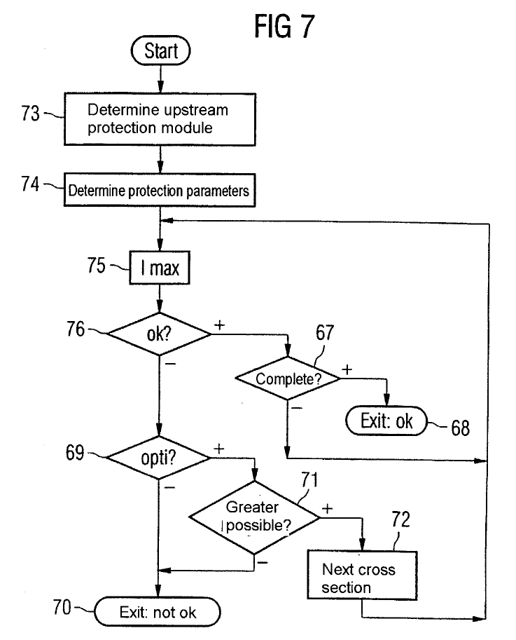

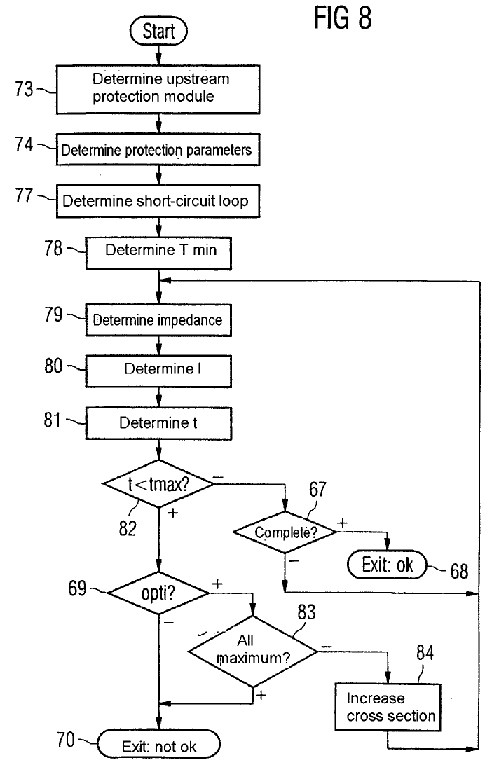

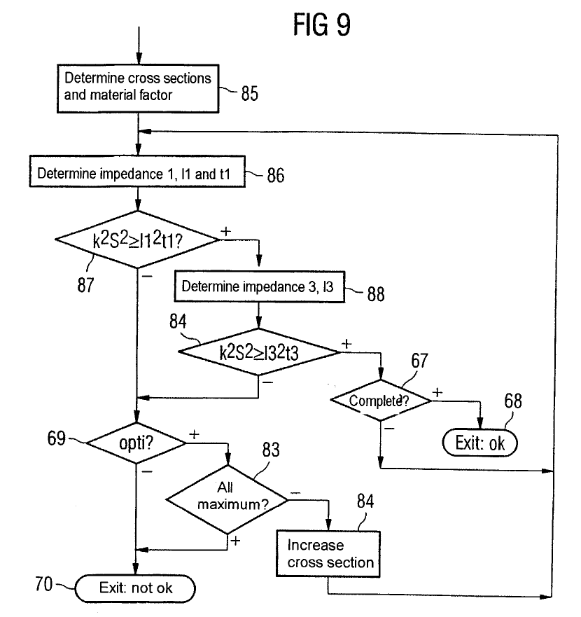

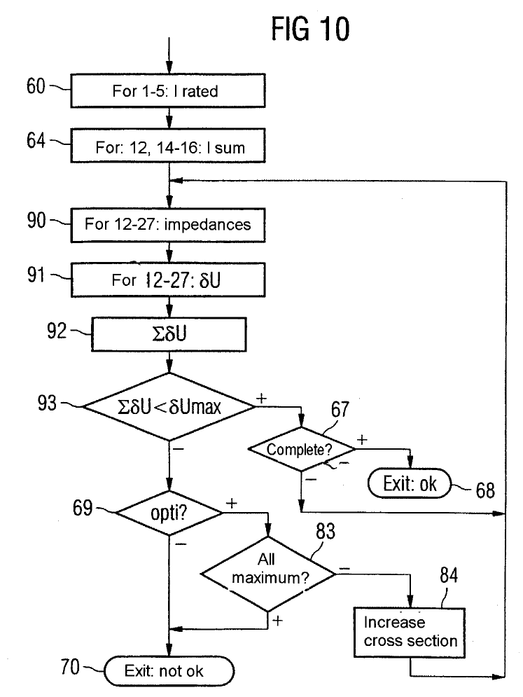

The fault message in step 47 comprises, in the simplest case, only the statement that a fault has occurred, that is to say that at least one of the sections 12 to 27 is not adequately designed. However, an indication is preferably provided—for example by means of an appropriate colored marking or, as indicated in FIG. 1, by a dashed-line frame—of the point at which the fault has occurred, for example in this case in the section 20. Furthermore, for example, by outputting an appropriate fault type, it is possible to inform the user 38 of the fault which has occurred. This is also indicated symbolically by the words “fault type” in FIG. 1. Based on FIG. 5, the test comprises steps 48 to 59. In step 48, sections 12 to 27 are tested for overloading during correct operation. This will be described in more detail in the following text, in conjunction with FIG. 6. In step 50, the sections 12 to 27 are checked to determine whether they are adequately designed for a predetermined overload. This will be described in more detail in the following text in conjunction with FIG. 7. In step 52, the sections 12 to 27 are checked for adequate design in the event of a wiring short circuit, and in step 54 they are checked for adequate design in the event of a load short-circuit. This will be described in more detail in the following text in conjunction with FIGS. 8 and 9. Finally, in step 56, the voltage drop is determined and a check is carried out to determine whether this can be tolerated, that is to say whether the sections 12 to 27 are also adequately designed for this purpose. This will be described in more detail in the following text in conjunction with FIG. 10. The test criteria for the steps 50, 52, 54 and 56 are in this case read from the file 40.

After each test in the steps 48, 50, 52, 54 and 56 and in the subsequent steps 49, 51, 53, 55 and 57, a check is carried out to determine whether the respective test has been successfully completed. Subsequent tests are carried out only if a preceding test has been successful. Otherwise, a jump is made directly to step 58, in which a status variable is set to the value “not satisfactory”. If, in contrast, all the tests are completed successfully, the status variable is set to the value of “satisfactory” in step 59.

According to FIG. 5, all the tests listed there are carried out. However, this is not absolutely essential. In particular, the test for overloading and short-circuiting of the loads may often be omitted. However, the sequence of the test steps carried out remain unchanged.

According to FIG. 6, in order to test the sections 12 to 27 for overloading during correct operation of the loads 1 to 5, the respective rated currents are first of all calculated in a step 60. The process of determining the currents in this case takes into account phase shifts of the currents flowing in the loads 1 to 5 with respect to the voltage supply. The currents are in this case preferably determined in complex form, since this allows the rest of the calculation process to be simplified. The currents flowing in the intermediate sections 13 and 17 as well as the currents flowing in the end sections 18 to 27 are thus known on the basis of the structure of the wiring system—see FIG. 1.

A check is then carried out in a step 61 to determine whether two or more of the loads 1 to 5 are single-phase loads. If yes, the loads are distributed between the phases of the wiring system in a step 62, in order to balance the load distribution. The distribution is then output to the user 38 in a step 63.

The total current flowing in the intermediate sections 14, 15 and 16 as well as the total current flowing in the bus section 12 are then calculated in a step 64. The determination process is carried out in the sequence 14-15-16-12. Any phase shifts are, of course, also taken into account in the calculation of the total currents. In this case as well, the computation complexity is at a minimum when the calculation is carried out using complex currents. This is advantageous especially with regard to the intermediate sections 14, 15, since this reduces the computation complexity.

The maximum permissible current for the end section 27 is then determined in a step 65 for this section. This is done by accessing the file 39 once again. Specifically, tables are read from the file 39, which contain lists of the cross sections for which current may flow in which cables. These lists of first of all used to determine, in principle, what the maximum current is which may flow in the end section 27. Tables are also read from the file 39 and are evaluated, in which reduction factors are determined for the respective cable type as a function of the laying conditions and of the operating temperature, on the basis of which the initially maximum permissible current for the section 27 is reduced. The tables have preferably been determined empirically and are kept in the file 39 in the form of look-up tables.

A check is then carried out in a step 66 to determine whether the maximum permissible current determined in this way is exceeded. If the current is not exceeded, a check is carried out in a step 67 to determine whether all the sections 12 to 27 have been tested. If yes, the test has been successfully completed. The routine is thus ended in a step 68, with the message that the routine has been ended successfully being output. Otherwise, the next section 12 to 27 is tested.

If the tested section is inadequately designed, the check is first of all carried out in a step 69 to determine whether the wiring system should be optimized. If not, the routine is left in a step 70, with a feedback message being produced relating to the test during which and in which of the sections 12 to 27 a design error has occurred.

A number of cable cross sections are available for use in the sections 12 to 27. If optimization is intended, a question is thus asked in a step 71 as to whether a larger cable cross section is available for the section 27 being tested at that time. If yes, an identical cable with the next larger cross section is used for the section 27, and the test is carried out once again, as in step 66. The computer thus carries out a reassignment of the cross section in this case. Otherwise, a jump is made to step 70.

According to FIG. 7, the upstream protection element is first of all determined, in a step 73, for each of the sections 12 to 27 in order to test the response of the design of the sections 12 to 27 to a predetermined overload. For the end sections 19, 21, 23, 25 and 27, this protection element is the respectively immediately upstream switching and protection modules 7 to 11. For the other sections 12 to 18, 20, 22, 24, 26, this is the supply module 6. If, by way of example, it is intended to insert a dedicated protection element in the intermediate section 14 (as is indicated by dashed lines in FIG. 1), this protection element would be relevant for the end sections 18 and 20, for the intermediate section 13 and for the intermediate section 14, assuming that it is connected to the sections 13 and 20.

The relevant parameters for the respective protection elements 6 to 11 are then read from the file 39 in a step 74. The program 37 is thus able to automatically determine the protection parameters of the respective modules 6 to 11, in this case first of all their rated current, the overload factor and overload time, and if required also the associated tolerances. The maximum permissible current is then once again determined for each section, in a step 75.

The rated current, the overload factor, the overload time and the maximum permissible current in the respective section 12 to 27 are then used to check, in a step 76, whether the relevant section 12 to 27 can carry the overload.

When testing for a predetermined overload, the steps 75 and 76 correspond to the steps 65 and 66 when testing for overloading when the loads are being operated correctly. The rest of the test for overloading in response to a predetermined overload is thus the same as that described above in conjunction with FIG. 6. This will therefore not be described in detail in the following text.

In order to test for adequate design of the sections 12 to 27 in the event of a short circuit in one of the sections 12 to 27, as shown in FIG. 8, the upstream protection element and its protection parameters—on this occasion the short-circuit protection parameters including the permissible tolerances—are first of all determined once again in steps 73 and 74. The tripping characteristic of the upstream protection element is particularly important in the context of FIG. 8.

The short-circuit loop in which the short-circuit current flows is determined next, in a step 77. The maximum permissible short-circuit temperatures of the individual cable types are then determined, and their minimum is formed, on the basis of the file 39, in a step 78. This temperature minimum is used to form impedances of the individual elements in the short-circuit loop, and their sum is formed in a step 79. Furthermore, the system impedance of the upstream network is also added, in a step 79. The short-circuit current can now be determined in a step 80, on the basis of the impedance determined in this way and the known network voltage. Finally, —if required taking account of permissible tolerances—the tripping time of the upstream protection element on the basis of the short-circuit current can be determined in a step 81 on the basis of the tripping characteristic.

The tripping time determined in this way is compared with the maximum permissible tripping time, in a step 82. The steps 67 to 70 are carried out once again—analogously to FIGS. 6 and 7—depending on the result of the comparison. Instead of the steps 71 and 72, slightly modified steps 83 and 84 may be carried out: a check is carried out in step 83 to determine whether the entire short-circuit loop has already been designed using the maximum cross section. If yes, the short-circuit condition cannot be satisfied, and a jump is made to step 70. Otherwise, in a step 84 and based on the bus section 12, the first sudden change in cross section in the short-circuit loop is searched for, and the cross section of the section downstream from the sudden change is increased by one step. If no sudden cross section change is found, the cross section of the bus section 12 is increased by one stage in step 84.

There is no need to carry out a test for the three-pole fault situation in the context of short-circuit tripping. This is because the short-circuit current in the event of the three-pole fault is at least as great as the short-circuit current in the event of a single-pole fault. Thus, if disconnection occurs at the correct time on the basis of a single-pole short circuit, disconnection will undoubtedly take place at the correct time in the event of a three-pole short circuit.

The next test in the method is determine whether the sections 12 to 27 are thermally overloaded in the event of a short circuit. No test is therefore carried out to determine whether the current which flows is sufficiently large to initiate short-circuit disconnection. This has already been tested above, in conjunction with FIG. 8. In fact, the test determines whether the sections 12 to 27 which are affected by a short circuit also overcome this until disconnection is carried out by the upstream protection element.

According to FIG. 9, the cross sections and material factors of the short-circuit loop under consideration are first of all determined in a step 85. In this case, the cross sections are already known, on the basis of the given configuration. The material factors can once again be found in the file 39. The impedance, the current and the tripping time for a single-pole short circuit are then determined once again, in a step 86. This activity corresponds to the combination of the steps 79 to 81 in FIG. 8.

A check is then carried out in a step 87 to determine whether the sections in the short-circuit loop are overloaded. A test is therefore carried out for each affected section 12 to 27 to determine whether it satisfies the condition k²S²≧I1²t1. In this case, k and S are the relevant material factors and cross sections, respectively, I1 and t1 are the single-pole short-circuit current and the tripping time in response to this current. If the condition is satisfied, the short-circuit loop is not overloaded in the event of a single-pole short circuit. The impedance for a three-phase short circuit and the short-circuit current which results from it are then determined in an analogous manner in a step 88. A table for the upstream protection element can then be used to determine the amount of short-circuit energy I3²t3 which must then be absorbed by the respective section 12 to 27. This short-circuit energy is compared in a step 89 with the energy absorption capacity k²S² for the respective cable, which has already been calculated in step 87.

Depending on the result of the two comparison processes in steps 87 and 89, it is possible to continue either with step 67, that is to say either the test is ended positively (step 68) or else the next short-circuit loop is tested. If the test result is negative, either the cross section is increased or else the program is terminated with a fault message, if appropriate in accordance with the known steps 69, 70, 83, 84.

The steps 60 and 64 are first of all carried out once again, as shown in FIG. 10, in order to determine the voltage drop. The (complex) rated currents are thus determined for loads 1 to 5, and the (complex) total currents are then determined for the intermediate sections 14 to 16 and for the bus suction 12. The impedance is then determined in a step 90, for each of the sections 12 to 27. A voltage drop is then determined in a step 91 for each of the sections 12 to 27, from the impedances in conjunction with the known rated voltage.

Finally, in a step 92, the sum of the resultant voltage drops is determined for one of the paths from the supply module 6 to one of the loads 1 to 5. This sum is compared in a step 93 with an—absolutely or relatively predetermined—limit value. Depending on the result of the comparison, either the next path is investigated on the basis of steps 66 and 67 or, after investigation of all the paths, the program is completed with a feedback message that the voltage drop condition is satisfied for all paths. Alternatively, when processing the steps 69, 70, 83, 84 there is either an increase in the cable cross section along the path, namely either at the first sudden change in cross section or at the bus section 12, or the routine is terminated with the feedback message that the voltage drop condition is not satisfied.

These calculations are carried out not only for the main wiring system but also, analogously, for the auxiliary wiring systems. The design criteria as such, that is to say for example the checking for overloading in the event of a short circuit, may in this case remain the same. The test algorithms must, of course, be appropriately adapted. The data obtained, that is to say the specifications of the elements 1 to 11, 28, 29 involved and of the sections 12 to 27 and of the corresponding sections of the auxiliary wiring systems, can now be stored in the file 41. All the tables and other characteristics to which access has been made in the course of the design of the wiring systems are in this case preferably also stored in the file 41. This is because it is in this way possible to carry out a check of the configuration process by calling up the file 41 at a later date, even if the catalogue file 39 is not available or—for example as a result of an update—contains other data.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A computer-aided test method for a wiring system, via which it is intended to be possible to supply a number of electrical loads (1-5) with low voltage from a supply module (6),
with a topology of the wiring system being entered in a computer (30),
with the wiring system, based on the topology, having at least one bus section (12), which is arranged between the supply module (6) and at least two of the loads (1-5), and having at least one individual section (18-27) for each load (1-5), which individual section (18-27) is arranged between the bus section (12) and this load (1-5), but no further loads (1-5),
with the bus section (12) and the individual sections (18-27) each having at least one associated dedicated length and at least one associated dedicated cross section, and the loads (1-5) having associated ratings,
with the low voltage, the ratings and the lengths in conjunction with predetermined design criteria for each section (12-27) being used to test whether the cross section is adequately designed.

2. The test method as claimed in claim 1, characterized
in that the design criteria include a test of the sections (12-27) for overloading during correct operation of the loads (1-5), during a predetermined overload, during a short-circuit in the sections (12-27) or in the loads (1-5), and/or a voltage drop in the sections (12-27).

3. The test method as claimed in claim 2, characterized
in that at least two of the tests mentioned in claim 2 are carried out, and in that the tests that are carried out are carried out in the sequence mentioned in claim 2.

4. The test method as claimed in claim 1, 2 or 3, characterized
in that, in accordance with the topology, at least two of the loads (for example 1, 2) are connected to the bus section (12) via a common intermediate section (for example 14), and at least one further load (for example 3) is connected to the bus section (12), but not via the common intermediate section (14),
in that the intermediate section (14) also has an associated dedicated length and an associated dedicated cross section, and
in that the low voltage, the ratings and the lengths in conjunction with the previously known design criteria are also used to test whether the intermediate section (14) is adequately designed.

5. The test method as claimed in claim 4, characterized
in that sections (13, 18-21) which connect loads (1, 2) to the bus section (12) together with the intermediate section (14) are tested first of all to determine whether they are adequately designed, and sections (22, 23) which connect loads (3) to the bus section (12) without the intermediate section (14) are only then tested to determine whether they are adequately designed.

6. The test method as claimed in one of the preceding claims, characterized
in that said test method automatically optimizes the sections (12-27) to ensure a minimum adequate design.

7. The test method as claimed in claim 6, characterized
in that the optimization of the sections (12-27) is initiated or suppressed by presetting an appropriate control command.

8. The test method as claimed in one of the preceding claims, characterized
in that laying conditions and/or operating temperatures which are associated with the sections (12-27) are also entered, and in that the laying conditions and/or the operating temperatures are taken into account during the testing of the sections (12-27), in order to determine whether they are adequately designed.

9. The test method as claimed in one of the above claims, characterized
in that, for at least some of the loads (1-5), in each case one switching and protection module (7-11), which is arranged upstream of the respective load (1-5), is specified for the computer (30).

10. The test method as claimed in claim 9, characterized
in that at least some of the design criteria are determined on the basis of protection parameters of the switching and protection modules (7-11).

11. The test method as claimed in one of the preceding claims, characterized
in that the loads (1-5), and possibly also the switching and protection modules (7-11), can be selected from a predetermined catalog (39), and in that load parameters as well as switching and protection module parameters, in particular the rating of the load (1-5) and the protection parameters of the switching and protection module (7-11), are determined automatically by the selection from the catalog (39).

12. The test method as claimed in one of the preceding claims, characterized
in that, if the design is inadequate, a fault message is generated, on the basis of which a design criterion which is not satisfied and/or a fault location can be identified.

13. The test method as claimed in one of claims 1 to 12, characterized
in that the low voltage is a DC voltage.

14. The test method as claimed in one of claims 1 to 12, characterized
in that the low voltage is a single-phase AC voltage.

15. The test method as claimed in one of claims 1 to 12, characterized
in that the low voltage is a three-phase AC voltage with three phases.

16. The test method as claimed in claim 15, characterized
in that at least two of the loads (1-5) are single-phase loads, in that the single-phase loads are distributed between the phases of the wiring system in order to carry out the test method, and in that the distribution between the phases is output to a user (38) of the test method.

17. The test method as claimed in claim 14, 15 or 16, characterized
in that phase shifts of the currents flowing in the loads (1-5) are taken into account when testing the sections (12-27) for adequate design.

18. The test method as claimed in one of the preceding claims, characterized
in that the tested and possibly optimized, wiring system is stored as a file (41), in particular as an ASCII file (41).

19. A test method, characterized
in that a test method as claimed in one of the preceding claims is carried out for at least two wiring systems, and in that the wiring systems have at least the supply module (6) as a common item.

20. The test method as claimed in claim 19, characterized
in that the wiring systems have at least one of the loads (7-11) as a common item.

21. The test method as claimed in claim 19, characterized
in that a switching and protection module (for example 8, 10) is arranged upstream of at least one of the loads (for example 2, 4) in one wiring system, and in that the switching and protection module (for example 8, 10) is a load (8, 10) in the other wiring system.

22. The test method as claimed in claims 19, 20 or 21, characterized
in that at least one of the wiring systems is operated with a DC voltage, in particular with a DC voltage of 24 V.

23. The test method as claimed in one of claims 19 to 22, characterized
in that at least one of the wiring systems is operated with a single-phase AC voltage, in particular with a single-phase AC voltage of 230 V.

24. The test method as claimed in one of claims 19 to 23, characterized
in that at least one of the wiring systems is operated with a three-phase AC voltage, in particular with a three-phase AC voltage of 400 V.

25. A configuration tool for carrying out a test method as claimed in one of the above claims.
